(19) United States
(12) Patent Application Publication
(10) Pub. No.: US 2004/0241082 A1
(43) Pub. Date: Dec. 2, 2004

(54) Method of reducing the solubility of calcium sulfate dihydrate in an aqueous suspension and method of making same

(76) Inventors: Bruce R Kerr, Montreal (CA); Balazs Tolnai, Montreal (CA)

Correspondence Address: James A Sheridan, Pandiscio & Pandiscio, 470 Totten Pond Road, Waltham, MA, 02451-1914, US

(21) Appl. No.: 10/486,762

(22) PCT Filed: Aug. 9, 2002
(86) PCT No.: PCT/CA02/01244

(30) Foreign Application Priority Data
Aug. 13, 2001 (CA) 2,355,027
Jan. 15, 2002 (CA) 2,367,593

(51) Int. Cl. C01F 11/46

(52) U.S. Cl. 423/555

(57) ABSTRACT

The suspension of needle-shaped (acicular) calcium sulfate dihydrate particles is prepared by mixing freshly calcined calcium sulfate hemihydrate (CaSO₄¹¹2?O), having an average particle size between 1 and 100 micrometers, and water in a reactor at medium to high shear rate, with either no additives or together with acids or with calcium or sulfate containing additives. The average length and width of the resulting calcium sulfate dihydrate particles are then about 5 to 35 micrometers and 1 to 5 micrometers, respectively. The calcium sulfate dihydrate particles of reduced solubility are obtained using a calcium chelating agent, with or without the addition of a weak acid. The resulting product is a suspension of calcium sulfate dihydrate particles that can be used as a filler in papermaking. The particles have a high retention and provide improved optical properties with minimal filler losses due to solubility.

The present invention relates to calcium sulfate (or sulphate) dihydrate having a reduced solubility in water and which is particularly suitable for use as a filler in paper. It also relates to a method of making a calcium sulfate dihydrate aqueous suspension.

To produce the paper, an aqueous suspension containing cellulose fibers, filler particles and additives, which suspension is also referred to as a stock, is provided in a papermaking machine. The stock is fed into a headbox which ejects the stock onto a forming wire through a slice opening in the papermaking machine. Water is drained from the stock through the forming wire so that a wet paper web is formed on the wire. The wet paper web is thereafter dewatered and dried in the drying section of the papermaking machine. Retention agents are usually introduced into the stock in order to increase adsorption of fine particles, including the filler particles, onto the cellulose fibers. However, due to incomplete retention, the water obtained by dewatering the stock and the wet web, referred to as whitewater or back water, contains fine particles not being retained on the paper web. The whitewater is either recycled or discarded after treatment.

Fillers are inert and finely-divided materials, most commonly minerals, that are mainly used to fill spaces between cellulose fibers so as to Improve the quality of paper and lower the quantity of cellulose fibers that needs to be used. They are commonly less expensive than wood fibers. Therefore, the advantages of incorporating filler particles in the stock comprise lower furnish cost, more efficient fiber resource use as well as improved optical and physical properties. Examples of these improved properties are printability, opacity, brightness, whiteness, softness, smoothness, etc. Conversely, fillers may weaken paper by interfering with fiber-fiber bonding. The possibility of increased pressroom breaks is usually a factor limiting the use of fillers.

Several different mineral fillers have been used hitherto by the paper industry. Among them, the most commonly-used mineral fillers are calcium carbonate, clay, titanium oxide and talc. Typical level of filler addition ranges from 5 to 25% by weight of the dry paper.

Calcium sulfate forms can be ideal filler candidates in papermaking, although their physical and chemical properties are different from any other conventional filler. Calcium sulfate fillers are known to provide Improved optical properties and a moderate strength loss. Their crystal form and crystal size can also be easily modified.

Gypsum is a naturally-occurring and widely-available mineral consisting of calcium sulfate dihydrate, which is one of the calcium sulfate forms. Although finely-grounded natural gypsum has been used in the past as a filler for paper, its use has been discontinued in papermaking because it had many drawbacks, such as high Impurities content, low brightness and particle fineness, excessive solubility, small specific surface area and poor retention in the paper web. More recently, attempts have been made to utilize precipitated tabular acicular calcium sulfate dihydrate to obtain a high filler retention, but solubility is still a concern.

It should be noted that gypsum also exists as a waste product, for example from the manufacture of phosphoric acid, often referred to as “chemical gypsum” or “by-product gypsum”.

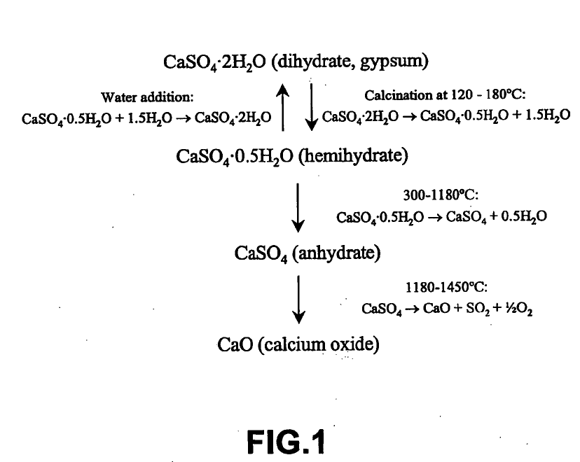

Calcium sulfate is known to exist in several different forms: calcium sulfate dihydrate or gypsum (CaSO₄. 2H₂O), hemihydrate (CaSO₄.½H₂O) and anhydrite (CaSO₄). During the calcination of calcium sulfate dihydrate at 120-180° C., gypsum loses 1.5 mol of its crystal water and calcium sulfate hemihydrate is formed. When water is added to the hemihydrate, the hemihydrate binds the missing crystal water and crystallizes into dihydrate. Hemihydrate at high temperature loses its residual crystal water and forms anhydrite. Anhydrite can not be converted back to hemihydrate or gypsum. At very high temperature anhydrate loses sulfur dioxide and oxygen and forms calcium oxide. The chemical equations illustrated in FIG. 1 summarize the above.

The high solubility of calcium sulfate dihydrate in water is indeed an important issue since during the papermaking, a huge amount of calcium sulfate filler is dissolved and cannot be retained by the paper web. As a result, the losses of material are significant when used as a filler in papermaking. The high concentration of calcium sulfate also increases the calcium and sulfate ion content of the whitewater and the effluent. This requires the whitewater and the effluent to be diluted, typically between 2 to 5 times, to avoid deposit formation and high calcium and sulfate contamination of the flow circuits of the papermaking machine. Such contamination is very difficult to remove.

From the above, it is apparent that there is the need of reducing the solubility of calcium sulfate dihydrate, more particularly the need of providing calcium sulfate dihydrate particles having a reduced solubility and solubility rate in an aqueous suspension, and a method of making such suspension and particles in a simple, fast and economical way using only a small amount of inorganic components.

There is also a need of producing calcium sulfate dihydrate particles for use as a filler in papermaking, which particles have a small size and a shape providing a high filler retention, good bonding in the paper web and less potential linting problems in the pressroom.

Accordingly, one aspect of the present invention is to provide a method of reducing the solubility of calcium sulfate dihydrate in an aqueous suspension, the method being characterized in that it comprises:

adding a calcium chelating agent to the suspension; and

agitating the suspension;

whereby the calcium chelating agent reacts with the calcium sulfate dihydrate so as to reduce the solubility thereof.

Another aspect of the present invention is to provide a calcium sulfate dihydrate suspension, characterized in that it comprises at least calcium sulfate dihydrate particles, water and a calcium chelating agent, whereby the calcium chelating agent reacts with the calcium sulfate dihydrate so as to reduce the solubility thereof.

A further aspect of the present invention is to provide a method of producing calcium sulfate dihydrate having a reduced solubility in water, characterized in that the method comprises:

forming an aqueous slurry of calcium sulfate dihydrate; and

mixing into the slurry a calcium chelating agent, the chelating agent comprising a salt of an inorganic acid;

whereby the calcium chelating agent reacts with the calcium sulfate dihydrate so as to reduce the solubility thereof.

Another further aspect of the present invention is to provide a method of producing particles of calcium sulfate dihydrate having an acicular shape and particle dimensions of about 1 to 5 micrometers in width and about 5 to 35 micrometers in length, the method being characterized in that it comprises:

a) providing powdered calcium sulfate hemihydrate having an average particle size of 1 to 100 micrometers;

b) forming an aqueous slurry containing 5% to 25% by weight of the powdered calcium sulfate hemihydrate;

c) mixing the slurry for 10 to 60 minutes at a temperature between 10 and 80° C.; and

d) adding a calcium chelating agent into the slurry;

whereby the calcium chelating agent reacts with the calcium sulfate dihydrate so as to reduce the solubility thereof.

These and other aspects and advantages of the present invention are described in or apparent from the following detailed description made in conjunction with the accompanying figures in which:

FIG. 1 illustrates the chemical equations of the various forms of calcium sulfate;

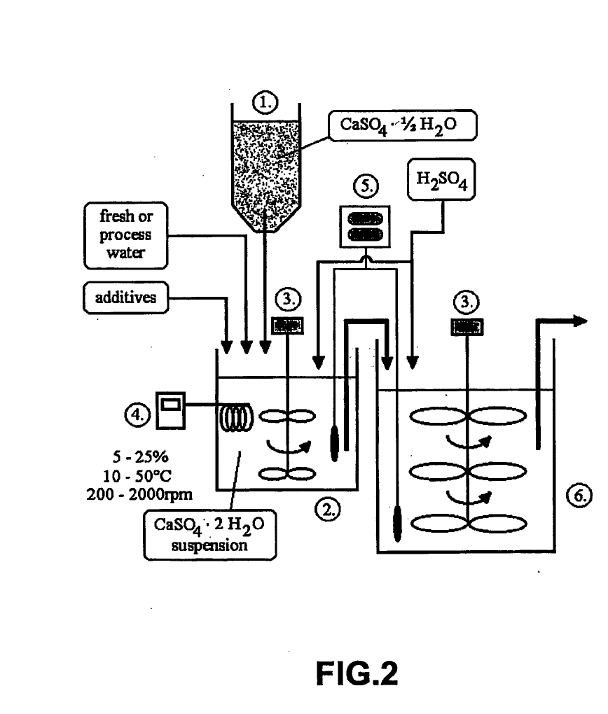

FIG. 2 is a schematic view of a system for producing the needle-shaped calcium sulfate dihydrate particles;

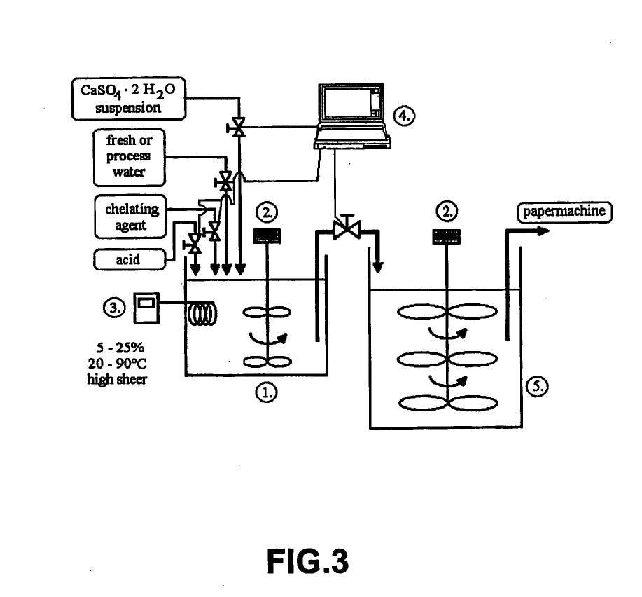

FIG. 3 is a schematic view of a system for producing the calcium sulfate dehydrate particles having a reduced solubility;

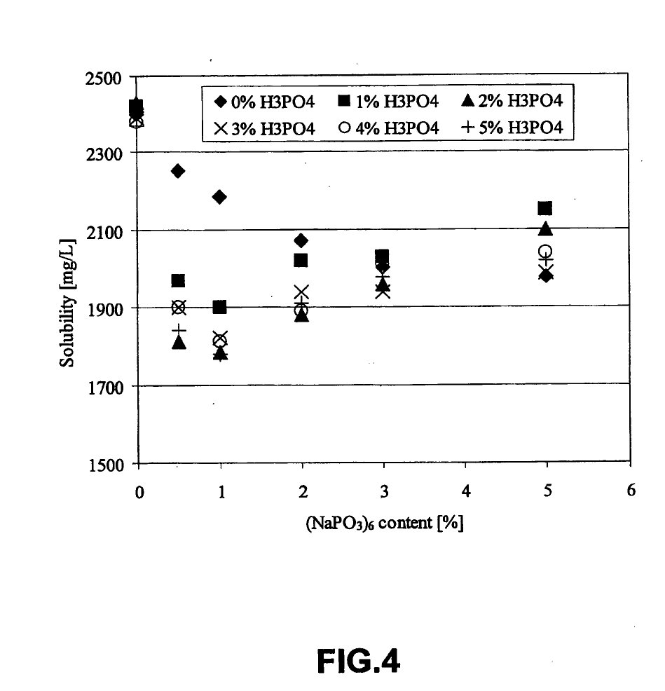

FIG. 4 is a graph showing the solubility of the calcium sulfate dihydrate particles compared to varying levels of sodium hexametaphosphate and phosphoric add at 20° C.:

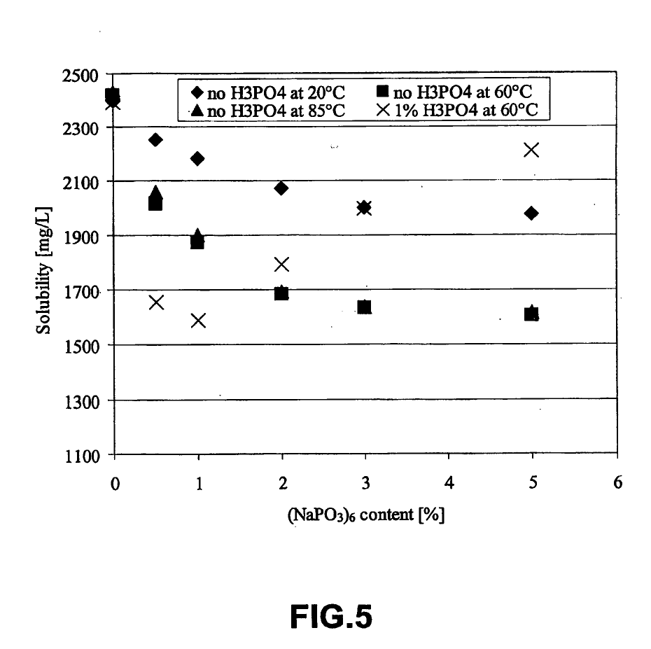

FIG. 5 is a graph showing the solubility of the calcium sulfate dihydrate particles compared to varying levels of sodium hexametaphosphate at different temperatures; and

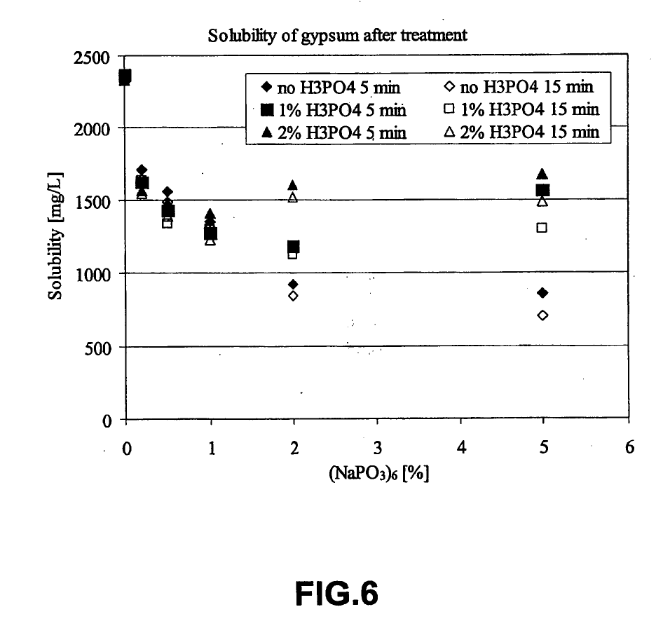

FIG. 6 is a graph showing the solubility of the calcium sulfate dihydrate particles compared to varying agitation times and varying levels of sodium hexametaphosphate and phosphoric acid at high temperature.

A first aspect of the present invention is concerned with producing calcium sulfate dihydrate particles, more particularly needle-shaped (acicular) calcium sulfate dihydrate particles with a particle size of about 1 to 5 micrometers by 5 to 35 micrometers, more preferably of about 1 to 3 micrometers by 5 to 25 micrometers. When used as a filler in papermaking, needle-shaped particles having a size within this range have been found to provide a satisfactory retention and a good bonding in the paper web as well as less potential linting problems in the pressroom.

In the method described, the needle-shaped calcium sulfate dihydrate particles are prepared by precipitating a calcium sulfate hemihydrate reactant in a continuously stirred atmospheric pressure reactor. Since the solubility of calcium sulfate hemihydrate is higher than that of calcium sulfate dihydrate, the hemihydrate slurry, with its low levels of supersaturation, provides an excellent medium for optimum crystal growth, thus, for the calcium sulfate dihydrate formation.

Freshly calcined calcium sulfate hemihydrate in a finely-divided powdered form, preferably with an average particle size of 1 to 100 micrometers, was found to be the best reactant. The hemihydrate can be calcined from natural gypsum or from by-product gypsum. The hemihydrate is preferably added to the mixing tank in a proportion between 50% and 25% by weight of the final aqueous suspension, at a temperature between 10° C. and 80° C., more preferably between 20° C. and 50° C. The mixture is maintained in suspension by stirring. The agitation is preferably at medium or high shear rate, which generally corresponds to an agitation speed between 100 rpm and 3000 rpm. More preferably, the agitation speed is between 500 rpm and 2000 rpm. These parameters are selected so as to allow for substantial total conversion of the hemihydrate into dihydrate crystal particles within a reasonable time.

It was found that the conversion from calcium sulfate hemihydrate to calcium sulfate dihydrate with no additives can be completed in about 10 to 60 minutes. It was also found that conversion can be accelerated, and the particle size modified, by using acids. Examples of such acids are sulfuric acid (H₂SO₄), sulphurous acid (H₂SO₃), hydrochloric acid (HCl), nitric acid (HNO₃), and mixtures thereof. These acids are preferably In a concentration from about 0.01% to 5% by weight of the final suspension. Yet, these acids can be used with or replaced by a calcium containing salt, a sulfate containing salt or an aluminum containing salt. Preferably, these salts are respectively a soluble salt of calcium, sulfate and aluminum. The concentration of these salts are about 0.01% to 5% by weight of the final suspension. Adding small amounts of fines or pulp to the suspension also proved to accelerate the conversion.

FIG. 2 illustrates an example of a preferred embodiment of a system in which the above-described method can be carried out. It comprises a calcium sulfate hemihydrate storage tank (1), a mixing tank (2), a motor-driven agitator (3), a heater (4), sensors (5) for measuring the pH, temperature, conductivity and the calcium content, and a calcium sulfate dihydrate storage tank (6) in which the aqueous suspension in the mixing tank (2) is to be transferred using a pump or another means (not shown). The calcium sulfate dihydrate storage tank (6) also comprises a motor-driven agitator (3). Fresh or process water and additives can be added to the mixing tank (2) through corresponding inlets. Operations of the system can be carried out either manually, semi-automatically or fully automatically with the use of a computer or an electronic circuit programmed for that purpose.

The resulting product from the above-described method is the aqueous suspension comprising needle-shaped calcium sulfate dihydrate crystal particles with a particle size of about 1 to 5 micrometers by 5 to 35 micrometers.

Advantageously, calcium sulfate dihydrate is the most stable form of calcium sulfate. It cannot bind any more crystal water, so its water slurry does not harden. Since the solubility of calcium sulfate dihydrate does not change significantly when varying the pH between about 4 to 9 and the temperature between 10° C. and 80° C., the calcium sulfate dihydrate slurry can be stored and transported in a tank without agitation. Yet, the produced calcium sulfate dihydrate suspension can be directly added as a filler to the papermaking furnish with relatively high retention. It can also be treated by further additives and heat to produce calcium sulfate dihydrate of reduced solubility, as explained hereinafter.

It has been found that the solubility of the calcium sulfate dihydrate can be reduced by adding a calcium chelating agent after the crystal formation, with or without the following addition of a weak acid at a higher temperature. The calcium chelating agent, together with the excess calcium ion content of the suspension, is believed to form a layer on the surface of the calcium sulfate particles, thus reducing their solubility. It should be noted that this method can be carried out using calcium sulfate dihydrate prepared using a method different than the one previously disclosed herein above.

The calcium chelating agent is preferably an alkali metal salt of a weak acid. The weak acid preferably has an acid dissociation constant value (Ka) between 10⁻¹ and 10⁻⁹, more preferably between 10⁻¹ and 10⁻³. Examples of possible calcium chelating agents are sodium-hexametaphosphate and sodium-tripolyphosphate. The calcium chelating agent can also be an alkali earth metal salt of a weak acid.

Following the addition of the chelating agent, a weak acid can be added to the mixture. The weak acid preferably has an acid dissociation constant value (Ka) between 10⁻¹ and 10⁻⁹, more preferably between 10⁻¹ and 10⁻¹. Examples of such weak acid are phosphoric acid (H₃PO₄), metaphosphoric acid (HPO₃)ₙ, hexametaphosphoric acid (HPO₃)₆, and mixtures thereof. However, the hexametaphosphoric add is preferred.

To obtain the calcium sulfate dihydrate with a reduced solubility, the calcium sulfate suspension is preferably mixed with calcium chelating agent at concentration ranging from about 0.001% to 10% by weight of the final suspension. If used, the weak acid is preferably in concentration ranging from about 0.001% to 10% by weight of the final suspension. Preferably, the mixture is held at a temperature from about 30° C. to 90° C. for 5 to 60 minutes with agitation at a medium to a high shear rate (500 to 2000 rpm) between 1 to 15 minutes to ensure a uniform mixing.

The above-described method is particularly well suited for calcium sulfate dihydrate, whether made from ground gypsum, by-product gypsum or from a precipitated form. The method also applies to the other forms of calcium sulfate, namely hemihydrate and anhydrate.

FIG. 3 illustrates an example of a preferred system in which the above-described method can be carried out It comprises a mixing tank (1), a motor-driven agitator (2), a heater (3), a computer (4) and a storage tank (5). The mixing tank (1) receives the calcium sulfate dihydrate suspension, the chelating agent and the weak acid, if any. Fresh or process water can also be added, if needed. The computer (4) preferably controls the various valves and elements to carry out the method. The suspension of calcium sulfate dihydrate particles with a reduced solubility is then transferred to the storage tank (5), where it is eventually used in the papermaking machine.

When used as a filler, the suspension calcium sulfate dihydrate can be directly added to pulp furnish (wood-free or wood containing; acid, neutral or alkaline) before paper formation. Advantageously, using the needle-shaped calcium sulfate dihydrate particles with a reduced solubility provides a higher filler retention, minimal filler losses due solubility and improved optical properties. Furthermore, depending on the filler level in the paper, using the filler of calcium sulfate dihydrate particles with a reduced solubility can decrease the energy consumption in the drying section of the papermaking machines of 2% to 15%.

### EXAMPLE 1

### Preparation of the Calcium Sulfate Dihydrate Suspension without Additives

In first a series of evaluation, calcium sulfate hemihydrate and water were fed to a mixing tank without additives at different levels of concentration, agitation and temperature (see Table 1, Sample 1 to 8). The system used to prepare the suspension was similar to that shown in FIG. 2. Freshly calcined calcium sulfate hemihydrate was used as reactant. The average particle size of the calcium sulfate hemihydrate was between 1 and 100 micrometers. The concentration of the calcium sulfate hemihydrate in the suspension varied between 5% and 25% by weight. In this example deionised water, tap water and process water were used.

In the first part of the example, in which Sample 1, Sample 2 and Sample 3 were tested, the effect of using deionised water, tap water and process water was compared.

No difference was found between using deionised or tap water. The conversion can be completed in the same time, and the particle size of the calcium sulfate dihydrate was identical. Using process water accelerated the conversion and made the particles somewhat bigger. This can be explained by the presence of fines. Those fines in the process water acted as nuclei for the crystal formation process.

Sample 4 and Sample 5 were then tested. For these samples, the calcium sulfate dihydrate suspension was prepared in tap water at lower consistency. The lower the concentration, the slower the conversion from calcium sulfate hemihydrate to calcium sulfate dihydrate, but the resulting particle size was the same.

TABLE 1
Example 1

| | | | Agitation | | | Filler | Filler |
|---|---|---|---|---|---|---|---|
| Sample | Consistency | Water | speed | Temperature | Conversion | length | width |
| No. | [%] | type | [rpm] | [° C.] | time [min] | [μm] | [μm] |
| 1 | 10 | deionised | 800 | 20 | 20 | 10-20 | 1-2 |
| | | water | | | | | |
| 2 | 10 | tap water | 800 | 20 | 20 | 10-20 | 1-2 |
| 3 | 10 | process | 800 | 20 | 14 | 15-20 | 1-2 |
| | | water | | | | | |
| 4 | 7.5 | tap water | 800 | 20 | 23 | 15-20 | 1-2 |
| 5 | 5 | tap water | 800 | 20 | 25 | 15-20 | 1-2 |
| 6 | 10 | tap water | 600 | 20 | 24 | 10-20 | 2-3 |
| 7 | 10 | tap water | 400 | 20 | 30 | 10-20 | 2-3 |
| 8 | 10 | tap water | 800 | 50 | 21 | 10-20 | 1-3 |

For Sample 6 and Sample 7, the calcium sulfate dihydrate suspension was prepared in tap water with slower agitation. The moderate agitation led to slower conversion from calsium sulfate hemihydrate to calsium sulfate dihydrate and somewhat thicker crystals.

For Sample 8, the calcium sulfate dihydrate suspension was prepared at higher temperature. No significant changes were observed either in conversion time or particle size, compared to lower temperatures.

### EXAMPLE 2

### Preparation of the Calcium Sulfate Dihydrate Suspension with Additives

In this example, calcium sulfate hemihydrate and water were fed to a mixing tank with additives at different levels of concentration (see Table 2, Sample 9 to 15). The same system was used as for Example 1.

Freshly calcined calcium sulfate hemihydrate was used as reactant. The average particle size of the calcium sulfate hemihydrate was between 1 and 100 micrometers. The concentration of the calcium sulfate hemihydrate was about 10% by weight. In this example, tap water and a 800 rpm agitation speed were used. The suspension was thermostated at 20° C.

In the first part of the example, namely with Sample 9 and Sample 10, the effect of acids on the calcium sulfate dihydrate formation was investigated. It was found that both the hydrochloric acid and the sulfuric acid made the precipitation faster. The sulfuric acid increased the sulfate ion content and the super saturation of the calcium sulfate in the system, resulting in faster precipitation than with the hydrochloric acid.

In the second part of the example, namely with Sample 11, Sample 12 and Sample 13, the effects of using calcium containing, sulfate containing and aluminum containing salts were investigated, All three additives resulted in faster precipitation, the calcium chloride and aluminum sulfate due to increased super saturation, and the aluminum chloride due to its acidic characteristic.

For Sample 14 and Sample 15, the effect of fines and pulp on the crystal formation was investigated. Both resulted in faster precipitation and somewhat bigger particles. This means process water (whitewater) can be used for the precipitation, which can also reduce the fresh water consumption.

TABLE 2
Example 2

| | Consist- | | Concen- | | Filler | Filler |
|---|---|---|---|---|---|---|
| Sample | ency | | tration | Conversion | length | width |
| No. | [%] | Additive | [%] | time [min] | [μm] | [μm] |
| 9 | 10 | H₂SO₄ | 1 | 16 | 15-25 | 1-3 |
| 10 | 10 | HCl | 2 | 18 | 10-20 | 1-2 |
| 11 | 10 | CaCl₂ | 1 | 15 | 15-25 | 1-3 |
| 12 | 10 | Al₂(SO₄)₃ | 1 | 15 | 15-25 | 1-3 |
| 13 | 10 | AlCl₃ | 1 | 18 | 10-20 | 1-2 |
| 14 | 10 | fines | 0.3 | 11 | 15-25 | 1-3 |
| 15 | 10 | pulp | 0.3 | 13 | 15-25 | 1-3 |

### EXAMPLE 3

### Effect of the Chelating Agent on the Solubility of the Calcium Sulfate Dihydrate Particles

In this example, a calcium chelating agent was added to the calcium sulfate dihydrate suspension produced from freshly calcined calcium sulfate hemihydrate according to Example 1, Sample 1. The suspension was agitated at high shear without or with the presence of a weak acid for short period of time. The solubility of calcium sulfate was measured thereafter. The system used was identical to that shown in FIG. 3.

For Sample 16, 500 g of calcium sulfate dihydrate suspension was prepared according to Example 1, Sample 1. The mixture was thermostated at 20° C. for 15 minutes. The solubility of calcium sulfate was then measured and found to be 2400 mg/L. This value was in good agreement with the literature value.

For Sample 17, 500 g of calcium sulfate dihydrate suspension was prepared according to Example 1, Sample 1. Thereafter, 0.5% to 5% by weight of sodium hexametaphosphate, based on calcium sulfate dihydrate, was added to the suspension, at 20° C., and the suspension was agitated for 15 minutes. The solubility of the treated calcium sulfate dihydrate was then measured. Results are summarized in the graph of FIG. 4. It was found that increasing sodium hexametaphosphate concentration gave decreased solubility. The curve is a saturation type curve, above a certain threshold, which is about 3% of sodium hexametaphosphate. The excess of sodium hexametaphosphate did not further decrease the solubility.

For Sample 18, 500 g of calcium sulfate dihydrate suspension was prepared according to Example 1, Sample 1. Thereafter, 0.5% to 5% by weight of sodium hexametaphosphate, based on calcium sulfate dihydrate, was added to the suspension, followed by the addition of 1% to 5% by weight of phosphoric acid, based on calcium sulfate dihydrate, at 20° C., and the mixture was agitated for 15 minutes. Results are summarized in FIG. 4. As can be seen, 1% of sodium. hexametaphosphate, based on calcium sulfate dihydrate, together with 2% phosphoric acid, based on calcium sulfate dihydrate, reduced the solubility of the calcium sulfate dihydrate by about 25%.

Further, it was found that, at a low sodium hexametaphosphate concentration, the effect of using phosphoric acid on the solubility of calcium sulfate dihydrate can be significant. However, at higher levels of concentration of sodium hexametaphosphate, the use of phosphoric acid was unnecessary.

### EXAMPLE 4

### Effect of the Chelating Agent on the Solublilty of the Calcium Sulfate Dehydrate Particles at Different Temperatures

For Sample 19, 500 g of calcium sulfate dihydrate suspension was prepared according to Example 1, Sample 1. Thereafter, 0.5% to 5% by weight of sodium hexametaphosphate, based on calcium sulfate dihydrate, was added to the suspension. Following the additions, the suspension was thermostated between 60° C. and 85° C. and agitated for 30 minutes. The solubility of the treated calcium sulfate dihydrate was then measured. Results are summarized in FIG. 5. The same system was used as for Example 3.

It was found that increasing temperature and increasing concentration of sodium hexametaphosphate resulted in a decrease of the solubility. The solubility curve of calcium sulfate dihydrate at 60° C. and at 85° C. was also a saturation type curve. Above 3% of sodium hexametaphosphate, based on calcium sulfate dihydrate, the solubility of calcium sulfate dihydrate did not decrease further. With 2% of sodium hexametaphosphate, based on calcium sulfate dihydrate, and a temperature of 60° C., the solubility of the calcium sulfate dihydrate decreased by about 30%. Increasing the temperature from 60° C. to 85° C. did not make any difference in the solubility of calcium sulfate dihydrate.

For Sample 20, 500 g of calcium sulfate dihydrate suspension was prepared according to Example 1, Sample 1. Thereafter, 0.5% to 5% of sodium hexametaphosphate, based on calcium sulfate dihydrate, was added to the suspension, followed by the addition of 1% phosphoric acid, based on calcium sulfate dihydrate. Following the additions, the suspension was thermostated between 60° C. and agitated for 30 minutes. The solubility of the treated calcium sulfate dihydrate was then measured. Results are also summarized in FIG. 5.

From FIG. 5, it can be seen that 1% sodium hexametaphosphate, based on calcium sulfate dehydrate, together with 1% phosphoric acid, based on calcium sulfate dihydrate, reduced the solubility of the calcium sulfate dihydrate by about 40%. It was found that at a low sodium hexametaphosphate concentration—between 0.5% and 2%, based on calcium sulfate dihydrate—the effect of using phosphoric acid on the solubility of calcium sulfate dihydrate can be significant. However, at higher levels of concentration of sodium hexametaphosphate, the use of phosphoric acid was unnecessary.

### EXAMPLE 5

### Effect of the Chelating Agent on Solubility of the Calcium Sulfate Dehydrate Particles

For Sample 21, 500 g of calcium sulfate dihydrate suspension was prepared according to Example 1, Sample 8 at 50° C. Immediately thereafter, 0.2% to 5% of sodium hexametaphosphate, based on calcium sulfate dihydrate, was added to the suspension, which was still thermostated at 50° C. The suspension was agitated for 5 to 15 minutes. The solubility of the treated calcium sulfate dihydrate was then measured. Results are summarized in FIG. 6. The same system was used as for Example 3 and Example 4.

It was found that using sodium hexametaphosphate at these conditions resulted in a dramatic solubility reduction. Moreover, It was found that 2% and 5% of sodium hexametaphosphate, based on calcium sulfate dihydrate, decreased the solubility of calcium sulfate dihydrate by 60% and 70%, respectively. Increasing sodium hexametaphosphate concentration gave decreased solubility. The curve was also a saturation type curve. The effect of time at high sodium hexametaphosphate concentration seems to be important.

For Sample 22, 500 g of calcium sulfate dehydrate suspension was prepared according to Example 1, Sample 8 at 50° C. Thereafter, from 0.2% to 5% of sodium hexametaphosphate, based on calcium sulfate dihydrate, was added to the suspension, followed by the addition of 1 to 2% phosphoric acid, based on calcium sulfate dihydrate. The suspension was thermostated at 50° C. The suspension was agitated for about 5 to 15 minutes. The solubility of the treated calcium sulfate dihydrate was then measured. Results are also summarized in FIG. 6.

From FIG. 6, it can be seen that in the range between 0.2% to 1% of sodium hexametaphosphate, the presence of phosphoric acid slightly decreased the solubility of calcium sulfate dihydrate in the suspension. However, above that concentration range, the phosphoric acid made the treatment worse.

The invention is not limited to the described embodiment and encompasses any alternative embodiments within the limits defined by the claims. Moreover, it is important to note that the calcium sulfate dihydrate suspensions prepared in accordance with the various disclosed methods can be used in other situations besides papermaking. The term “Filler” used throughout the description should not exclude these other applications.

What is claimed is:

1. A method of reducing the solubility of calcium sulfate dihydrate in an aqueous suspension, the method being characterized in that it comprises:
adding a calcium chelating agent to the suspension; and
agitating the suspension;
whereby the calcium chelating agent reacts with the calcium sulfate dihydrate so as to reduce the solubility thereof.

2. A method according to claim 1, characterized in that the calcium chelating agent is an alkali metal salt of a weak acid.

3. A method according to claim 1, characterized in that the calcium chelating agent is an alkali earth metal salt of a weak acid.

4. A method according to claim 2, characterized in that the weak acid has a Ka between 10⁻¹ and 10⁻⁹.

5. A method according to claim 2, characterized in that the weak acid has a Ka between 10⁻¹ and 10⁻³.

6. A method according to claim 1, characterized in that the calcium chelating agent is sodium-hexametaphosphate

7. A method according to claim 1, characterized in that the calcium chelating agent is sodium-tripolyphosphate.

8. A method according to claim 1, characterized in that the method further comprises adding a weak acid to the suspension following the addition of the calcium chelating agent.

9. A method according to claim 8, characterized in that the subsequently-added weak acid has a Ka between 10⁻¹ and 10⁻⁹.

10. A method according to claim 8, characterized in that the subsequently-added weak acid has a Ka between 10⁻¹ and 10⁻³.

11. A method according to claim 8, characterized in that the subsequently-added weak acid is selected from a group consisting of phosphoric acid, metaphosphoric acid, hexametaphosphoric acid, and mixtures thereof.

12. A method according to claim 8, characterized in that the subsequently-added weak acid is hexametaphosphoric acid.

13. A method according to claim 8, characterized in that the subsequently-added weak acid is in amount of 0.001% to 10% by weight of the final suspension.

14. A method according to claim 1, characterized in that the suspension is held at a temperature from about 30° C. to 90° C. for about 5 to 60 minutes following the addition of the calcium chelating agent.

15. A method according to claim 1, characterized in that the final suspension is agitated for about 1 to 15 minutes.

16. A method according to claim 1, characterized in that the calcium sulfate dihydrate suspension is formed from a primary aqueous suspension of a powdered calcium sulfate hemihydrate reactant.

17. A method according to claim 16, characterized in that the calcium sulfate hemihydrate reactant is obtained from freshly calcined finely-ground powdered natural gypsum.

18. A method according to claim 16, characterized in that the calcium sulfate hemihydrate reactant is obtained from freshly calcined finely-ground powdered by-product gypsum.

19. A method according to claim 16, characterized in that the calcium sulfate hemihydrate reactant has an average particle size of about 1 to 100 micrometers.

20. A method according to claim 16, characterized in that the calcium sulfate hemihydrate reactant in the suspension is in a proportion between about 5% and 25% by weight of the final primary suspension.

21. A method according to claim 16, characterized in that the primary suspension is held at a temperature between about 10° C. and 80° C.

22. A method according to claim 21, characterized in that the temperature of the primary suspension is between about 20° C. and 50° C.

23. A method according to claim 16, characterized in that comprising adding an acid to the primary suspension in order to accelerate conversion of the calcium sulfate hemihydrate reactant into calcium sulfate dihydrate.

24. A method according to claim 23, characterized in that the acid added to the primary suspension is selected in a group consisting of sulfuric acid, sulphurous acid, hydrochloric acid, nitric acid, and mixtures thereof.

25. A method according to claim 23, characterized in that the acid added to the primary suspension is in a concentration from about 0.01% to 5% by weight of the final primary suspension.

26. A method according to claim 16, characterized in that the method further comprises adding a salt to the primary suspension in order to accelerate conversion of the calcium sulfate hemihydrate reactant into calcium sulfate dihydrate.

27. A method according to claim 26, characterized in that the salt added to the primary suspension is selected in a group consisting of soluble salt of calcium, soluble salt of sulfate and soluble salt of aluminum.

28. A method according to claim 26, characterized in that the salt added to the primary suspension is in a concentration from about 0.01% to 5% by weight of the final primary suspension.

29. A method according to claim 16, characterized in that the method further comprises adding fines or pulp to the primary suspension.

30. A calcium sulfate dihydrate suspension suitable for use in papermaking, characterized in that it comprises calcium sulfate dihydrate filler particles made according to the method of claim 1.

31. A calcium sulfate dihydrate suspension, characterized in that it comprises at least calcium sulfate dihydrate particles, water and a calcium chelating agent; whereby the calcium chelating agent reacts with the calcium sulfate dihydrate so as to reduce the solubility thereof.

32. A calcium sulfate dihydrate suspension according to claim 31, characterized in that the calcium chelating agent is an alkali metal salt of a weak acid.

33. A calcium sulfate dihydrate suspension according to claim 31, characterized in that the calcium chelating agent is an alkali earth metal salt of a weak acid.

34. A calcium sulfate dihydrate suspension according to claim 32, characterized in that the weak acid has a Ka between 10⁻¹ and 10⁻⁹.

35. A calcium sulfate dihydrate suspension according to claim 32, characterized in that the weak acid has a Ka between 10⁻¹ and 10⁻³.

36. A calcium sulfate dihydrate suspension according to claim 31, characterized in that the calcium chelating agent is sodium-hexametaphosphate.

37. A calcium sulfate dihydrate suspension according to claim 31, characterized in that the calcium chelating agent is sodium-tripolyphosphate.

38. A calcium sulfate dihydrate suspension according to claim 31, characterized in that the suspension further comprises a weak acid in the suspension.

39. A calcium sulfate dihydrate suspension according to claim 38, characterized in that the weak acid has a Ka between 10⁻¹ and 10⁻⁹.

40. A calcium sulfate dihydrate suspension according to claim 38, characterized in that the weak acid has a Ka between 10⁻¹ and 10⁻³.

41. A calcium sulfate dihydrate suspension according to claim 38, characterized in that the weak acid is selected from a group consisting of phosphoric acid, metaphosphoric acid, hexametaphosphoric acid, and mixtures thereof.

42. A calcium sulfate dihydrate suspension according to claim 38, characterized in that the weak acid is hexametaphosphoric acid.

43. A calcium sulfate dihydrate suspension according to claim 38, characterized in that the weak acid is in a concentration from about 0.001% to 10% by weight of the final suspension.

44. A calcium sulfate dihydrate suspension according to claim 31, characterized in that the calcium sulfate dihydrate particles are needle-shaped, the particles having an average length and width of about 5 to 35 micrometers and 1 to 5 micrometers, respectively.

45. A calcium sulfate dihydrate suspension according to claim 44, characterized in that the average length and width of the calcium sulfate dihydrate particles are about 5 to 25 micrometers and 1 to 3 micrometers, respectively.

46. A calcium sulfate dihydrate suspension according to claim 31, characterized in that it further comprises fines or pulp in the suspension.

47. A method of producing calcium sulfate dihydrate having a reduced solubility in water, characterized in that the method comprises:
forming an aqueous slurry of calcium sulfate dihydrate; and
mixing into the slurry a calcium chelating agent; the
chelating agent comprising a salt of an inorganic acid;
whereby the calcium chelating agent reacts with the calcium sulfate dihydrate so as to reduce the solubility thereof.

48. A method according of claim 47, characterized in that the inorganic acid is a weak acid.

49. A method according to claim 48, characterized in that the weak acid has a Ka between 10⁻¹ and 10⁻⁹.

50. A method according to claim 48, characterized in that the weak acid has a Ka between 10⁻¹ and 10⁻³.

51. A method according to claim 48, characterized in that the acid is a phosphoric acid.

52. A method according to claim 48, characterized in that the chelating agent is an alkali metal salt of the inorganic acid.

53. A method according to claim 52, characterized in that the chelating agent is chosen from sodium hexametaphosphate and sodium tripolyphosphate.

54. A method according to claim 47, characterized in that the chelating agent is added in an amount of between 0.001% and 10% by weight of the final suspension.

55. A method according to claim 47, characterized in that it further comprises adding a weak acid to the suspension following the addition of the chelating agent.

56. A method according to claim 55, characterized in that the subsequently-added weak acid has a Ka between 10⁻¹ and 10⁻⁹.

57. A method according to claim 55, characterized in that the subsequently-added weak acid has a Ka between 10⁻¹ and 10⁻³.

58. A method according to claim 55, characterized in that the subsequently-added weak acid is an inorganic acid.

59. A method according to claim 56, characterized in that the inorganic acid is a phosphoric acid.

60. A method according to claim 56, characterized in that the subsequently-added weak acid is chosen from the group consisting of phosphoric acid, metaphosphoric acid, hexametaphosphoric acid, and mixtures thereof.

61. A method according to claim 55, characterized in that the subsequently-added weak acid is added in an amount of 0.001% to 10% by weight of the final suspension.

62. A method according to claim 47, characterized in that the slurry containing the chelating agent is agitated for 1 to 15 minutes after addition of the chelating agent.

63. A method according to claim 62, characterized in that it further comprises maintaining the slurry containing the chelating agent for 5 to 60 minutes at 30 to 90° C.

64. A method of producing particles of calcium sulfate dihydrate having an acicular shape and particle dimensions of about 1 to 5 micrometers in width and about 5 to 35 micrometers in length, the method being characterized in that it comprises:
(a) providing powdered calcium sulfate hemihydrate having an average particle size of 1 to 100 micrometers;
(b) forming an aqueous slurry containing 5% to 25% by weight of the powdered calcium sulfate hemihydrate; and
(c) mixing the slurry for 10 to 60 minutes at a temperature between 10 and 80° C.; and
(d) adding a calcium chelating agent into the slurry;
whereby the calcium chelating agent reacts with the calcium sulfate dihydrate so as to reduce the solubility thereof.

65. A method according to claim 64, characterized in that in step c), the slurry is mixed at an agitation speed between 100 to 3000 rpm.

66. A method according to claim 65, characterized in that the agitation speed is between 500 to 2000 rpm.

67. A method according to claim 64, characterized in that the slurry is maintained at a temperature of between 20 and 50° C.

68. A method according to claim 64, characterized in that an acid is added to the slurry in an amount of between 0.01% and 5% by weight to accelerate conversion of calcium sulfate hemihydrate to calcium sulfate dihydrate.

69. A method according to claim 68, characterized in that the added acid is chosen from the group consisting of sulfuric acid, sulphurous acid, hydrochloric acid, nitric acid, and mixtures thereof.

70. A method according to claim 64, characterized in that a salt is added to the slurry in an amount of between 0.01% and 5% by weight to accelerate conversion of calcium sulfate hemihydrate to calcium sulfate dihydrate.

71. A method according to claim 70, characterized in that the added salt is a soluble salt containing calcium, sulfate, or aluminum components.

72. A method according to claim 64, characterized in that the added chelating agent is a salt of a weak acid.

73. A method according to claim 72, characterized in that the weak acid has a Ka between 10⁻¹ and 10⁻⁹.

74. A method according to claim 72, characterized in that the weak acid has a Ka between 10⁻¹ and 10⁻³.

75. A method according to claim 64, characterized in that the chelating agent is an alkali metal salt of the inorganic acid.

76. A method according to claim 64, characterized in that it further comprises adding a weak acid to the chelating agent.

77. A method according to claim 76, characterized in that the subsequently-added weak acid has a Ka between 10⁻¹ and 10⁻⁹.

78. A method according to claim 76, characterized in that the subsequently-added weak acid has a Ka between 10⁻¹ and 10⁻³.

79. A method according to claim 76, characterized in that the subsequently-added weak acid is an inorganic acid.

80. A calcium sulfate dihydrate suspension, characterized in that it is formed according to the method of claim 47.
